(19) United States
(12) Patent Application Publication
(10) Pub. No.: US 2008/0074612 A1
(43) Pub. Date: Mar. 27, 2008

(54) Executive style progressive ophthalmic lens

(76) Inventors: James Joseph Kent, Glendora, CA (US); Baden Lee Kent, Glendora, CA (US)

Correspondence Address: Dr. James J. Kent, 861 E Juanita Ave., Glendora, CA, 91740, US

(21) Appl. No.: 11/519,498

(22) Filed: Sep. 12, 2006

(51) Int. Cl. G02C 7/06

(52) U.S. Cl. 351/169

(57) ABSTRACT

Presented is a projectile (slug), which may be solid or hollow, encased in a sabot made of a semi-ridged material, usually plastic such as Teflon, with an arrangement to keep it in contact with the inner walls of a smooth bore weapon and automatically rotate, for stabilization, from the force of the expanding gases, while in the barrel, and wind pressure after this device exits the muzzle.

### BACKGROUND OF THE INVENTION

| | |
|---|---|
| US Cl | 351/171; 351/169 |
| Field of search | 351/168, 176 |

References Cited
U.S. PATENT DOCUMENTS

| | | |
|---|---|---|
| 1,143,316 | Poullain et al | Jun. 15, 1915 |
| 1,271,356 | Paige | July, 1918 |
| 1,351,785 | Paige | Sept. 07, 1920 |
| 1,518,405 | Glancy | Dec. 09, 1924 |
| 1,588,559 | Tillyer | June, 1926 |
| 2,109,474 | Evans | Mar. 01, 1938 |
| 2,310,925 | Bardwell et al | Feb. 16, 1943 |
| 2,405,989 | Beach | Aug. 20, 1946 |
| 2,475,275 | Birchall | Jul. 05, 1949 |
| 2,743,649 | Phillips | May, 1956 |
| 2,847,804 | Calkins et al | August, 1958 |
| 2,878,721 | Kanolt | March, 1959 |
| 3,687,528 | Maitenez | August, 1972 |
| 3,711,181 | Tagnon | January, 1973 |
| 3,785,724 | Maitenez | January, 1974 |
| 4,762,408 | Shinohara | Aug. 09, 1988 |
| 5,455,642 | Kazutoshi | Oct. 03, 1995 |
| 5,506,630 | Yasunori et al | Apr. 09, 1996 |
| 5,867,246 | Edwards | Feb. 02, 1999 |
| 6,213,603 | Altheimer et al | Apr. 10, 2001 |
| 6,669,337 | Welke | Dec. 30, 2003 |
| 6,712,467 | Kitani | Mar. 30, 2004 |
| 6,793,340 | Morris | Sep. 21, 2004 |
| 6,837,580 | Senda | Jan. 04, 2005 |
| 6,860,806 | Kaga | Feb. 08, 2005 |
| 6,883,916 | Menezes | Apr. 26, 2005 |
| 6,886,938 | Menezes | May 03, 2005 |
| 7,004,601B2 | Wang et al | May 16, 2006 |
| 7,066,597B2 | Miller | Jun. 27, 2006 |

Progressive ophthalmic lenses are commonly used eyeware to assist wearers who have difficulty focusing the crystalline lens for near vision, especially when reading. This function is known as accommodation.

The progressive ophthalmic lens is normally divided into three portions. An upper portion that serves for distant vision, a lower portion that serves for near vision and an intermediate portion that makes the transition between distant and near vision. This is accomplished in some of the prior art by either generating a transition and near vision curve along the same optical axis as the base curve which results in a near knife edge, in extreme cases, and an intolerable lateral edge problem. This requires the use of an angle generator ring to bring the rear or second surface into conformity with the first surface. The most often used method, recently, is by molding the lens and warping the lateral edges. This results in a narrow visual channel through the transition portion with a more or less flare for the near vision portion. This causes some wearers to have forms of vertigo and or nausea when he or she looks sideways through the lens until the wearer learns to turn his or her head, instead of the eyes, to the side.

It is the intention of this invention to create a progressive ophthalmic lens that alleviates the afore mentioned classic problems.

### SUMMARY OF THE INVENTION

It is the object of the present invention to provide a progressive ophthalmic lens on which the surface lateral aberrations and the knife edge problems are at the least minimized and possibly overcome and alleviate the difficulties related to the prior art.

### BRIEF DESCRIPTION OF THE SEVERAL VIEWS OF THE DRAWING

FIG. 1 is an isometric view of lens L showing the distribution of the various centers of curvature, the three different viewing portions and the minimal edge effect laterally, which will disappear when the lens L has its final edging.

FIG. 2 through FIG. 4 shows the graphic method of determining the location of the various centers of curvature (CCD, CCT, CCN).

FIG. 5 through FIG. 7 illustrates a method of generating the various curves by the possible use of a numerically controlled mill.

FIG. 8 shows the standard power law curve, used by the ophthalmic industry, that shows the power distribution of a lens formed under the conditions of the present invention. Shown is an extreme example of a 3 diopter add.

FIG. 9 & FIG. 10 is prior art that illustrates the lower knife edge effect.

FIG. 11 is an example of how the edge is affected according to the methods of fabrication using the present invention although this effect is later removed.

FIG. 12 illustrates an example of a standard right eyewire (frame) superimposed on a lens with high power add and how it ignores the edge effect according to this invention.

FIG. 13 is an illustration of the geometric and mathematical methods of describing an locating the various centers of curvature.

### DETAILED DESCRIPTION OF THE INVENTION

In referring to the various figures of the drawings here below, like reference letters will be used to refer to identical parts.

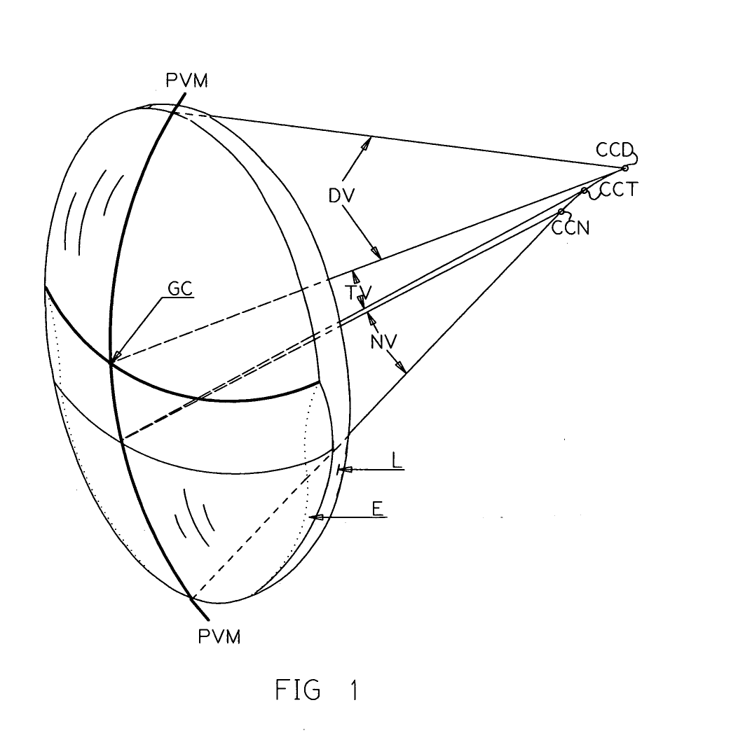

The lens L, shown in FIG. 1 may be made from any clear or tinted material that is of optical quality such as glass, or one of the well known plastic materials such as CR-39 (allyldiglycol carbonate), Lexan (polycarbonate), or methylmethacrylate, although it is not the intention of this invention to limit the material to these mentioned. For purposes of this description the lens L is shown in space as it would be worn by the wearer. The front, or convex, surface of the lens is normally the one chosen for the power of the lens. The rear or second surface usually receives all other corrections for the wearers eye. The lens L consists of three, not necessarily equal, nor necessarily three zones, an upper distant vision zone DV which usually utilizes a dioptric power between −10 and +10 both without any demarcation lines. This is accomplished by utilizing ever increasing radii of curvature thus the dioptric power of lens L until the power of NV is reached, and according to the wearer's prescription and is used for distant viewing. The lower portion of lens L is used for near and reading vision NV. The central or intermediate zone is the transition zone TV. These three zones are generated along the prime vertical meridian PVM in a manner to be described here. The geometric center GC of lens L may or may not be the optical center of lens L which will be determined by where the distant vision zone, DV, starts along the PVM. The centers of curvature, CCD, CCT and CCN are distributed in the plane of PVM, along what is known as an involute, according to means that will be described here. The edge effect E is shown in FIG. 1 as it will result in the finished uncut lens L (unedged). The result of final edging will eliminate this edge effect. The upper and lower zones DV and NV are of constant radius of curvature whereas TV is a constant increase in power. This transition portion TV extends from the lower edge of the distant vision zone DV to the upper edge of the near vision zone NV and is tangent to by making each vertical segment small enough that each zone may be blended in using a flexible polisher.

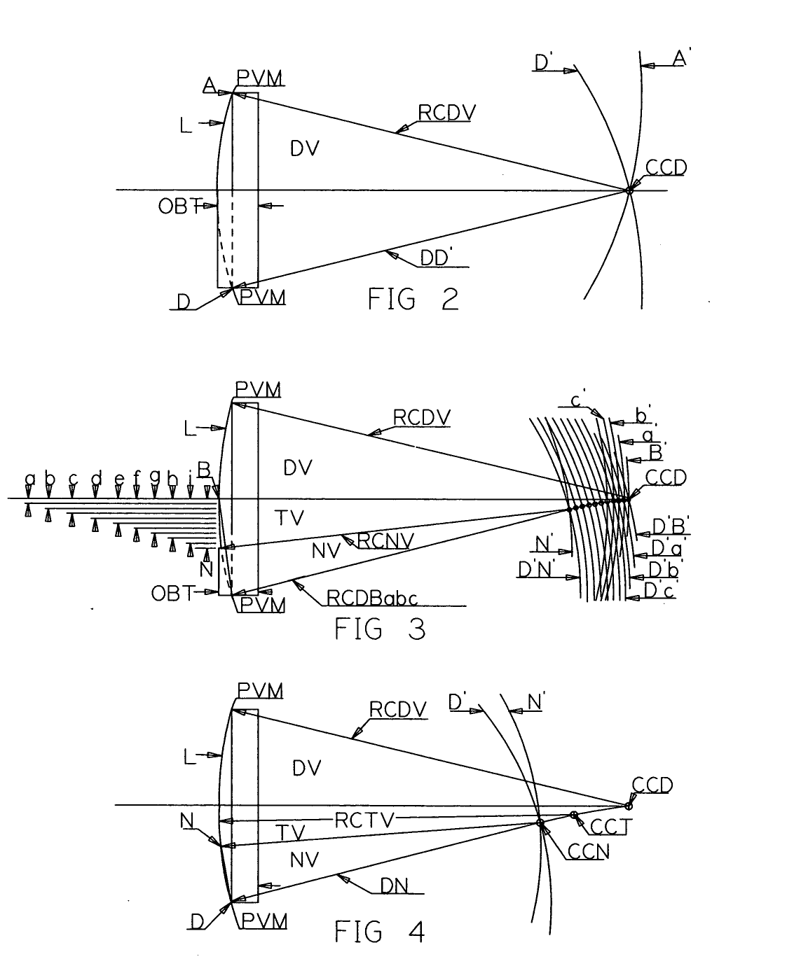

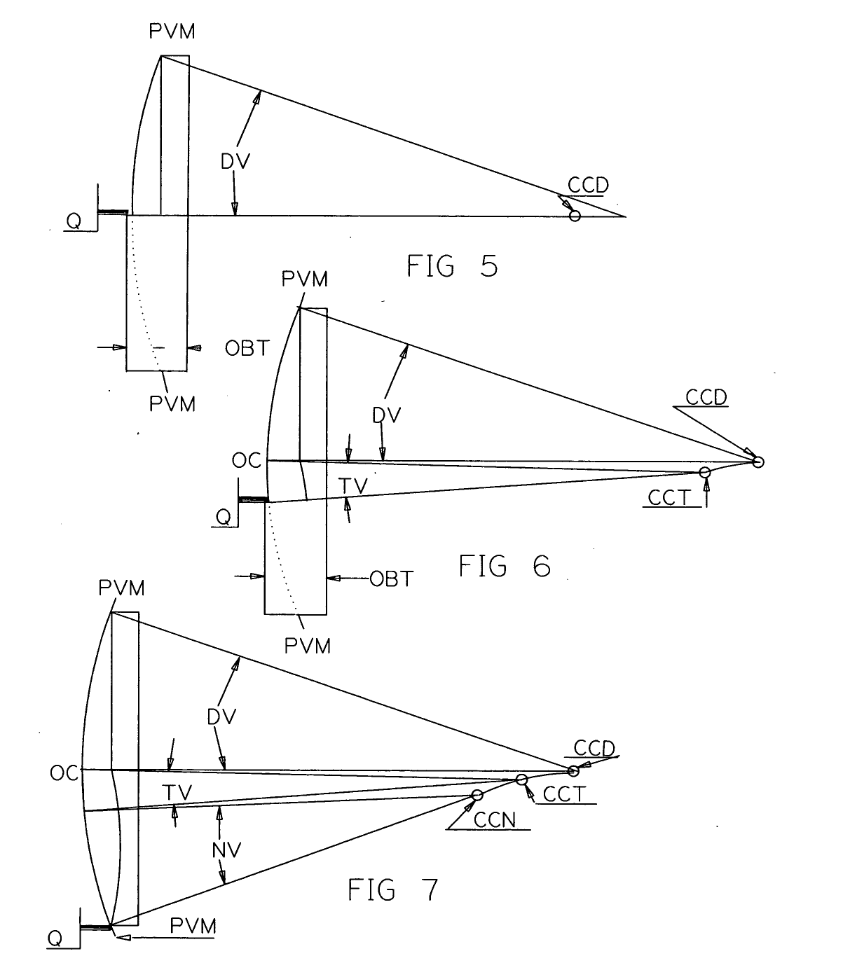

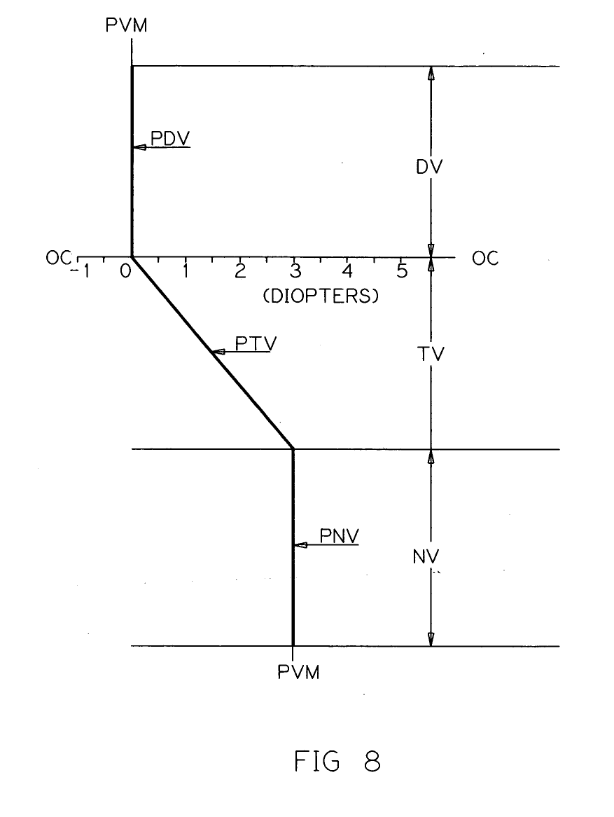

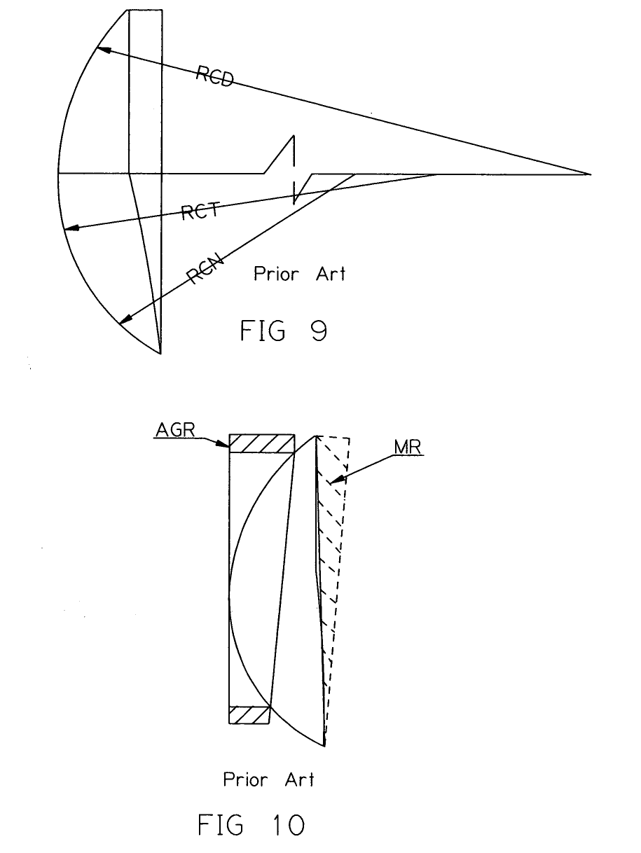

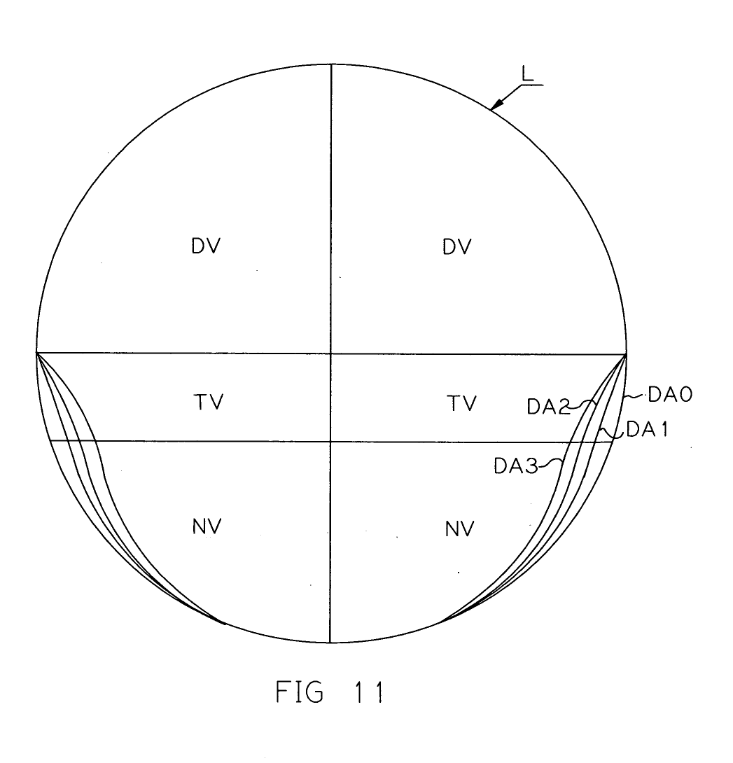

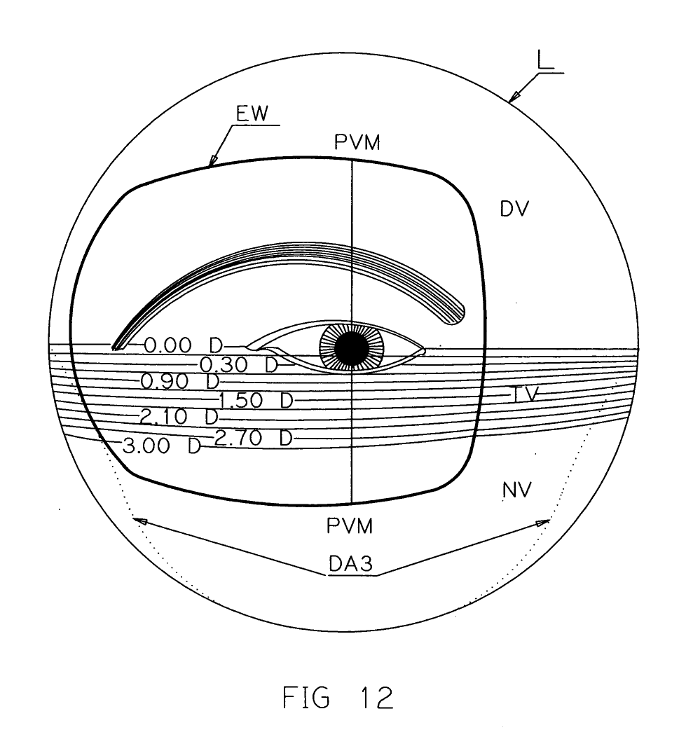

FIG. 2 to FIG. 4 illustrates a geometric method of locating the locus of centers of curvature. OBT is the original block thickness of the ophthalmic material from which lens L is to be fabricated. A is the top finished uncut edge of lens L and D is the bottom finished uncut edge. The line between them becomes the base of an equilateral triangle, as it will be for all segments along PVM. Striking an arc with A as the center results in the arc A′. Striking an arc with D as the center results in the arc D′. The intercept of arcs A′ and D′ results in the center of curvature CCD of the distant vision zone DV, and is the apex of an equilateral triangle and establishes the one important center of arc for all zones on the prime vertical meridian PVM at the point D regardless of their radii of curvature. No matter where the upper arc strikes from, the lower arc will always strike from D, which will make all curves along the PVM intercept the same lower edge. This is essential in solving the above mentioned problems of knife edge and lateral edge destruction, and is the most essential part of this invention. Each step or minute segment along the PVM will have it's center of curvature located by the intercept of an arc struck from the ending of a previous segment and one struck from D as shown in FIG. 3 and FIG. 4. In FIG. 3 B marks the start of the transition zone and the associated steps a, b and c of lens L and in these figures RCDV stands for the radius of curvature of the distance vision zone, RCTV the mean radius of curvature of transition zone and RCNV the radius of curvature of the near vision zone. In other words the transition zone would start with an arc struck from B, which is the terminus of DV, and one struck from D. The length of both arcs is the radius of curvature for that zone. If D is the dioptric power of the given zone Then R=((n−1)1000)/D. Where they intercept at B′D′ is the center of curvature, CCB, for segment B the first segment of the transition zone regardless of its length along PVM. It's radius of curvature is the length of a line from the intercept B′D′ to B. Point a is the start of the next segment of the transition zone which is tangent to the end of segment B. An arc is struck from the terminus of B and forms a′. An arc is struck from D and forms D′a′. Their intercept forms the center of curvature for the segment a which may or may not be the same length along PVM as segment B. This procedure is continued for segment b, an arc is struck from the end of segment a and one from D. Where they intercept D′b′ is the center of curvature for segment b, the segments will normally be of the same length but this is not required for this invention. Segment c is next. An arc is struck from the terminus of segment b and one from D their intercept at D′c′ becomes the center of curvature for segment c and so on until the transition zone terminates at the dioptric value of the near vision zone NV. Since the point D is common to all segments its radii are identified by DD′ in FIG. 2, by DB, a, b, c in FIG. 3 and in FIG. 4 as DN. The mathematical method of locating the centers of curvature of each segment is shown and discussed with FIG. 8 which shows the geometry mathematics of finding the center of curvature CC of any segment along the PVM. The distance C to D is the cord length of the segment, which may be as short as 1 mm. Y is the half cord of C to D and is 90° to the height H. Being an isosceles triangle for all segments the length of both sides will be the segment radii R. D will be the common end point for all segments. h is the sagita or height of the apex of the curve from the cord, and CCDc is the apex of the triangle and the location of the center of curvature of the segment. The radius or half diameter of the lens L is rl. s is the angle that the radius of curvature R of the segment makes with the semi-cord Y. P is the locus of segment centers of curvature. B is the vertex of lens L and the geometric center GC of lens L. This geometry can also be used for the concave mold from which to form the lens L. FIG. 5 is a rendition of how a small diamond coated quill can be used to generate all of the segments necessary to form the lens L from the center of curvature CCD described in FIG. 2. The quill Q generates the material along PVM and at the same time oscillates laterally to each edge about the same center of curvature CCD that the quill is associated with its position on PVM. FIG. 6 shows the same procedure for the transition zone TV in that the quill in this case will follow the locus of centers of curvature D′B′,D′a′D′b′, D′c′, etc. till the end of the transition zone TV where it meets the near vision zone NV. FIG. 7 continues on the same center of curvature CCN for NV until it crosses the intercept of PVM and the lower edge of lens L. The result is an Executive Style Progressive Ophthalmic lens finished but uncut (unedged). FIG. 8 illustrates the standard power law for an ophthalmic lens. PDV is the power of the distance vision DV shown as zero since there will be no final power till the rear or second surface is introduced. PTV is the power of the transition zone relative to the distance vision curve DV. PNV then is the power of the near vision zone NV relative to the distance vision zone DV. FIG. 9 shows prior art and the result of generation when the locus of centers of curvature are on axis. FIG. 10, also prior art, is an example of how an angle generator ring AGR has to be used to align the rear or second surface to conform to the alignment of the front or first the effect that may result at the lateral edges of lens L when using the method described herein. DA0 is the resulting edge if the lens were generated for only distant vision. DA1 for a lens with 1 diopter add NV. DA2 for a 2 diopter add NV and DA3 for a 3 diopter add NV. FIG. 12 is the same lens L as in FIG. 11 except for a human eye, with a pupillary distance of 64 mm, and a standard frame or eyewire EW. The numerals show the various powers along PVM and laterally to each edge of the cut (edged) frame. Even though this lens has an extreme add DA3, of 3 diopters, the edge effect is minimal and the distance vision DV can be started above or below the geometric center. One of the principle points of the lens is that there is no need to fabricate a left and right lens. No need to rotate the lens for near vision. One lens serves both eyes with the PVM vertical.

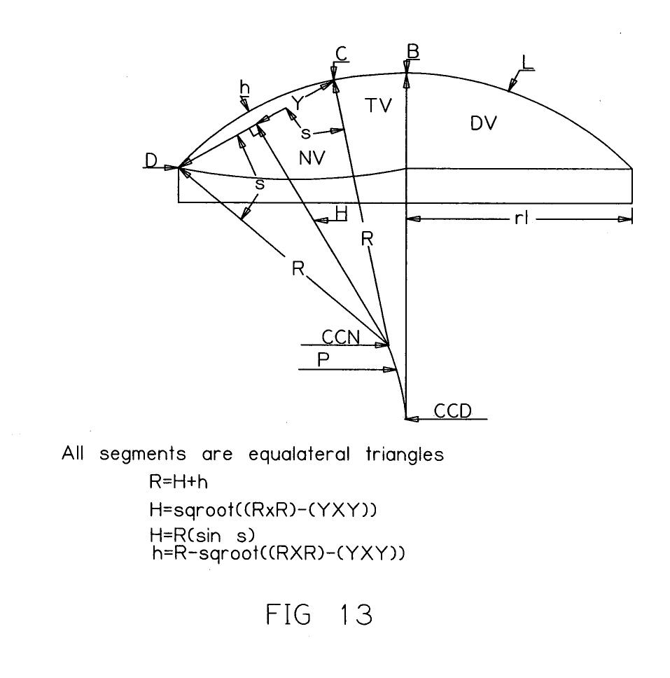

FIG. 13 shows the geometric and mathematical method of locating the centers of curvature for the various segments alone PVM. CCD is the center of curvature for the distance vision zone DV, which is a constant radius of curvature from the right or top edge of the lens L to the point B. P is the locus of the centers of curvature for the transition segments TV extending from B to C. CCN is the center of curvature for the near vision zone NV which is a constant radius of curvature R. The curve extends from C to D along the PVM. h is the sagita from the cord C-D to the vertex of the curve for that segment. Y is the semicord forming a right angle with H the bisection of the isoscelise triangle CCN, C, D. s are the equal angles at the base of the isoscelise triangle, rl is the radius, or half diameter, of the lens L.

1. A progressive ophthalmic spectacle lens having multiple centers of curvature and a multiplicity of radii of curvature having at least one area of vision, but normally three, the upper portion of the lens normally for distance vision, a lower portion dedicated to near vision and a transition and intermediate zone where the dioptric power progressively varies from a first point, which may be located anywhere on the prime vertical meridian to a second point on the prime vertical meridian. The first point is usually tangent to the lower portion of the distance vision zone, if there is one, and the second point is usually tangent to the top of the near vision zone, if there is one. In the case of vocational lenses where the wearer needs intermediate and near vision there may not be any distance vision zone and so with a wearer who needs only distance vision and intermediate vision there may be no need for the near vision portion, whose prime vertical meridian is a smooth, ever increasing dioptric power generated from a locus of points in the plane of the of the prime vertical meridian which divides the lens into two equal left and right or lateral zones. Each zone consisting of spherical curves having the same radius of curvature as its associated tangent point on the prime vertical meridian, with the plane of the front, or first surface edge generally circular with less than 8% edge loss at the transition and near vision zones which, after final edging, will leave an undistorted field of view across the entire width of the lens for any horizontal zone. Although this progressive ophthalmic spectacle lens is primarily designed for spectacle frames it may also serve other ophthalmic purposes.

2. While most of the present day progressive ophthalmic spectacle lenses require a toe-in to account for convergence of the eyes in near vision the present invention whose primary concern is for clear vision across the entire lens leaves no requirement for toe-in when the wearer scans from a lower power to a higher power making it possible that the same lens serves the right and left eye.

3. A progressive ophthalmic spectacle lens whose centers of curvature lie along a lissajous figure below the primary or Z axis, but in the plane of the vertical or Y axis, allows perfect spherical power in the lateral zone while causing its lower edge to be the same thickness as its top edge.
